(19) United States
(12) Patent Application Publication
(10) Pub. No.: US 2019/0158160 A1
(43) Pub. Date: May 23, 2019

(54) DATA SENDING METHOD, DATA RECEIVING METHOD, DATA SENDING APPARATUS, AND DATA RECEIVING APPARATUS

(71) Applicant: Huawei Technologies Co., Ltd., Shenzhen (CN)

(72) Inventors: Ye WU, Shanghai (CN); Yong LIU, Shanghai (CN); Xiaoyan BI, Shanghai (CN)

(21) Appl. No.: 16/259,144

(22) Filed: Jan. 28, 2019

Related U.S. Application Data
(63) Continuation of application No. PCT/CN2017/090805, filed on Jun. 29, 2017.

(30) Foreign Application Priority Data
Aug. 10, 2016 (CN) 201610652565.7

(51) Int. Cl. H04B 7/0456; H04B 7/06; H04L 5/00

(52) U.S. Cl. CPC H04B 7/0456; H04B 7/0617; H04L 5/0053; H04L 5/0023; H04L 5/0048

(57) ABSTRACT

This application provides a data sending method, a data receiving method, a data sending apparatus, and a data receiving apparatus. The method includes: precoding, by a transmit end device, a plurality of spatial flows, to obtain a plurality of precoded data streams, and transmitting the plurality of precoded data streams, where at least two spatial flows in the plurality of spatial flows are obtained by performing transmit diversity processing on one original spatial flow. In this way, some spatial flows in a plurality of spatial flows on a same time-frequency resource can be transmitted in a transmit-diversity-based beamforming transmission manner, and other spatial flows can be transmitted in a spatial multiplexing manner, thereby improving time-frequency resource utilization.

### CROSS-REFERENCE TO RELATED APPLICATIONS

This application is a continuation of International Application No. PCT/CN2017/090805, filed on Jun. 29, 2017, which claims priority to Chinese Patent Application No. 201610652565.7, filed on Aug. 10, 2016. The disclosures of the aforementioned applications are incorporated by reference herein in their entireties.

### TECHNICAL FIELD

This application relates to communications technologies, and in particular, to a data sending method, a data receiving method, a data sending apparatus, and a data receiving apparatus.

### BACKGROUND

In a Long Term Evolution (LTE) or a Long Term Evolution-advanced (LTE-A) system, a multiple-input multiple-output (MIMO) technology is used. In the MIMO technology, a plurality of antennas are deployed on a transmit end device and a receive end device, so that performance of a wireless communications system can be remarkably improved. For example, in a diversity scenario, the MIMO technology can effectively improve transmission reliability; and in a multiplexing scenario, the MIMO technology can improve a transmission throughput many fold.

In the diversity scenario, a base station usually transmits data by using an open loop transmit diversity (OLTD) method, where cell-level transmit diversity coverage can be formed through OLTD to provide reliable signal quality for user equipment (UE) in a cell. However, a same time-frequency resource can be used by only one UE, and other UEs cannot use the time-frequency resource, leading to a time-frequency resource waste.

### SUMMARY

This application provides a data sending method, a data receiving method, a data sending apparatus, and a data receiving apparatus, so that time-frequency resource utilization can be improved.

According to a first aspect of this application, a data sending method is provided, including: precoding, by a transmit end device, a plurality of spatial flows, to obtain a plurality of precoded data streams, and transmitting the plurality of precoded data streams. At least two spatial flows in the plurality of spatial flows are obtained by performing transmit diversity processing on one original spatial flow. In this way, some spatial flows in a plurality of spatial flows on a same time-frequency resource can be transmitted in a transmit-diversity-based beamforming transmission manner, and other spatial flows can be transmitted in a spatial multiplexing manner, thereby improving time-frequency resource utilization.

Further, the method further includes: precoding, by the transmit end device, demodulation reference signals of the plurality of spatial flows, to obtain a plurality of precoded demodulation reference signals, and sending the plurality of precoded demodulation reference signals. Each spatial flow corresponds to one demodulation reference signal, and a precoding vector used by each spatial flow is the same as a precoding vector used by the demodulation reference signal of each spatial flow.

According to a second aspect of this application, a data receiving method is provided, including: receiving, by a receive end device, a plurality of precoded data streams, where the plurality of precoded data streams are obtained by precoding a plurality of spatial flows, and at least two spatial flows in the plurality of spatial flows are obtained by performing transmit diversity processing on one original spatial flow; and then restoring the at least two spatial flows from the plurality of precoded data streams, and restoring the original spatial flow based on the at least two spatial flows.

The method further includes: receiving a plurality of precoded demodulation reference signals, where the plurality of precoded demodulation reference signals are obtained by precoding demodulation reference signals of the plurality of spatial flows, each spatial flow corresponds to one demodulation reference signal, and a precoding vector used by each spatial flow is the same as a precoding vector used by the demodulation reference signal of each spatial flow; and correspondingly, restoring, by the receive end device, the at least two spatial flows from the plurality of precoded data streams based on precoded demodulation reference signals of the at least two spatial flows.

According to a third aspect of this application, a data sending apparatus is provided, including: a processing module and a sending module. The processing module is configured to precode a plurality of spatial flows, to obtain a plurality of precoded data streams. The sending module is configured to transmit the plurality of precoded data streams. At least two spatial flows in the plurality of spatial flows are obtained by performing transmit diversity processing on one original spatial flow.

The processing module is further configured to precode demodulation reference signals of the plurality of spatial flows, to obtain a plurality of precoded demodulation reference signals, and the sending module is further configured to send the plurality of precoded demodulation reference signals. Each spatial flow corresponds to one demodulation reference signal, and a precoding vector used by each spatial flow is the same as a precoding vector used by the demodulation reference signal of each spatial flow.

According to a fourth aspect of this application, a data receiving apparatus is provided, including: a receiving module and a processing module. The receiving module is configured to receive a plurality of precoded data streams, where the plurality of precoded data streams are obtained by precoding a plurality of spatial flows, and at least two spatial flows in the plurality of spatial flows are obtained by performing transmit diversity processing on one original spatial flow. The processing module is configured to: restore the at least two spatial flows from the plurality of precoded data streams, and restore the original spatial flow based on the at least two spatial flows.

The receiving module is further configured to receive a plurality of precoded demodulation reference signals, where the plurality of precoded demodulation reference signals are obtained by precoding demodulation reference signals of the plurality of spatial flows, each spatial flow corresponds to one demodulation reference signal, and a precoding vector used by each spatial flow is the same as a precoding vector used by the demodulation reference signal of each spatial flow. In one embodiment, the processing module is configured to restore the at least two spatial flows from the plurality of precoded data streams based on precoded demodulation reference signals of the at least two spatial flows.

In one embodiment, in the methods and the apparatuses provided in the first aspect to the fourth aspect of this application, the original spatial flow corresponds to a first receive end device.

In one embodiment, in the methods and the apparatuses provided in the first aspect to the fourth aspect of this application, at least one spatial flow in the plurality of spatial flows corresponds to a second receive end device.

In one embodiment, in the methods and the apparatuses provided in the first aspect to the fourth aspect of this application, at least two spatial flows in the plurality of spatial flows are obtained by performing transmit diversity processing on another original spatial flow, and the another original spatial flow corresponds to a third receive end device.

In one embodiment, in the methods and the apparatuses provided in the first aspect to the fourth aspect of this application, the transmit diversity processing is space-time transmit diversity processing, space-frequency transmit diversity processing, or space-time-frequency transmit diversity processing.

In one embodiment, in the methods and the apparatuses provided in the first aspect to the fourth aspect of this application, different spatial flows correspond to different precoding vectors, each precoding vector corresponds to one demodulation reference signal (DMRS) port, and different precoding vectors correspond to different DMRS ports.

According to the data sending method, the data receiving method, the data sending apparatus, and the data receiving apparatus that are provided in this application, the transmit end device precodes the plurality of spatial flows, to obtain the plurality of precoded data streams, and transmits the plurality of precoded data streams, where at least two spatial flows in the plurality of spatial flows are obtained by performing transmit diversity processing on one original spatial flow. In this way, some spatial flows in a plurality of spatial flows on a same time-frequency resource can be transmitted in a transmit-diversity-based beamforming transmission manner, and other spatial flows can be transmitted in a spatial multiplexing manner, thereby improving time-frequency resource utilization.

### BRIEF DESCRIPTION OF DRAWINGS

FIG. 1 is a schematic diagram of a downlink physical channel processing procedure used in an existing LTE system;

FIG. 2 is a flowchart of a data sending method according to one embodiment;

FIG. 3 is a flowchart of a data receiving method according to one embodiment;

FIG. 4 is a schematic structural diagram of a data sending apparatus according to one embodiment;

FIG. 5 is a schematic structural diagram of a data receiving apparatus according to one embodiment;

FIG. 6 is a schematic structural diagram of a data sending apparatus according to one embodiment; and

FIG. 7 is a schematic structural diagram of a data receiving apparatus according to one embodiment.

### DESCRIPTION OF EMBODIMENTS

Methods in this application may be applied to a MIMO system, for example, an LTE system or an LTE-A system. In the MIMO system, a plurality of antennas are deployed on a transmit end device and a receive end device, so that performance of a wireless communications system can be remarkably improved. For example, in a diversity scenario, the MIMO technology can effectively improve transmission reliability; and in a multiplexing scenario, the MIMO technology can improve a transmission throughput many fold.

An important branch of the MIMO technology is precoding. In a precoding technology, a to-be-transmitted signal is processed by using a precoding matrix that matches an attribute of a channel, so that a precoded to-be-transmitted signal is adapted to the channel. Therefore, a transmission process is optimized, and received signal quality (for example, a signal to interference plus noise ratio (SINR)) is improved. Currently, the precoding technology is adopted in a plurality of wireless communications standards, including but not limited to an LTE system.

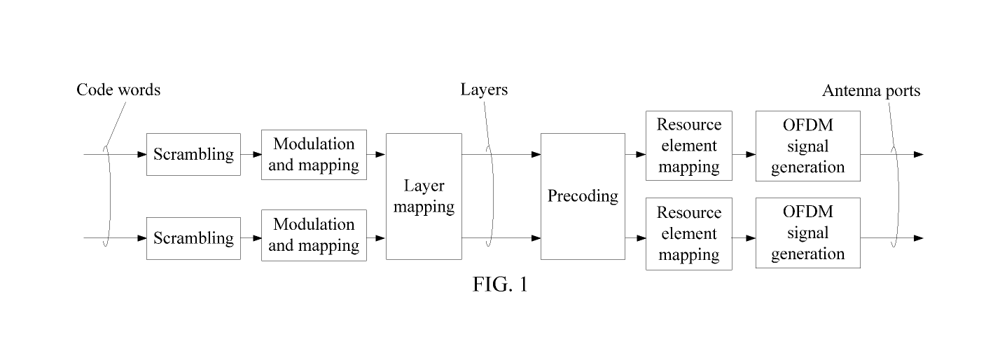

FIG. 1 is a schematic diagram of a downlink physical channel processing procedure used in an existing LTE system. A to-be-processed object in the downlink physical channel processing procedure is a code word, and the code word is generally a bit stream on which coding (including at least channel coding) has been performed. The code word is scrambled to generate a scrambled bit stream. The scrambled bit stream is modulated and mapped, to obtain a modulated symbol stream. Layer mapping is performed on the modulated symbol stream, and the modulated symbol is mapped to a plurality of symbol layers (also referred to as spatial flows or spatial layers). Precoding is performed on the symbol layers to obtain a plurality of precoded symbol streams. Resource element mapping is performed on the precoded symbol streams, so that the precoded symbol streams are mapped to a plurality of resource elements. Subsequently, the resource elements experience an orthogonal frequency division multiplexing (OFDM) signal generation stage (for example, Inverse Fast Fourier Transform (IFFT)), to obtain an OFDM symbol stream. Subsequently, the OFDM symbol stream is transmitted through an antenna port.

An important application of the MIMO technology is transmit diversity. In the transmit diversity, redundancy transmission is performed on an original signal (for example, a symbol) in a time dimension, a frequency dimension, a space dimension (for example, an antenna), or various combinations of the three dimensions, to improve transmission reliability. In one embodiment, a quantity of redundancy transmissions may be set based on a channel model or channel quality, and a redundancy transmission object may be an original signal, or may be an original signal on which processing has been performed, where the processing may include, for example but not limited to, processing such as delaying, negation, conjugating, and rotating, and processing that is obtained after the foregoing types of processing are derived, evolved, and combined.

Currently, common transmit diversity includes, for example but not limited to, diversity manners such as space-time transmit diversity (STTD), space-frequency transmit diversity (SFTD), time switched transmit diversity (TSTD), frequency switched transmit diversity (FSTD), and orthogonal transmit diversity (OTD), and diversity manners that are obtained after the foregoing diversity manners are derived, evolved, and combined.

The foregoing provides a general description of transmit diversity by way of example. A person skilled in the art should understand that in addition to the foregoing examples, the transmit diversity is further implemented in a plurality of other manners. Therefore, the foregoing description should not be construed as a limitation on the technical solutions of this application, but the technical solutions of this application should be understood as being applicable to all possible transmit diversity schemes.

The transmit diversity may be classified, based on whether channel state information fed back by a receive end device is relied on or not, into channel state information (CSI) independent OLTD and CSI-dependent closed loop transmit diversity. An LTE system and an LTE-A system use OLTD, and cell-level coverage is formed through OLTD. UE using an OLTD transmission scheme exclusively uses a time-frequency resource, and other UE cannot share the time-frequency resource through spatial multiplexing, leading to a time-frequency resource waste.

To resolve the prior-art problem, an embodiment of this application provides a data sending method, so that spatial multiplexing can be performed when a transmit diversity technology is used, thereby improving time-frequency resource utilization.

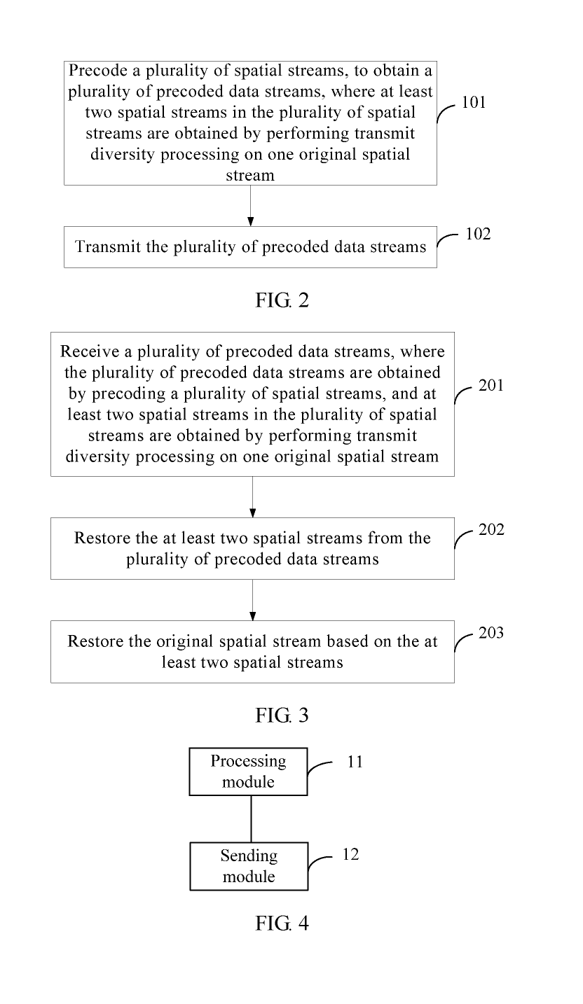

FIG. 2 is a flowchart of a data sending method according to one embodiment. The method in this embodiment is performed by a transmit end device. The transmit end device may be a base station or UE. As shown in FIG. 2, the method in this embodiment includes the following steps:

Step 101: Precode a plurality of spatial flows, to obtain a plurality of precoded data streams, where at least two spatial flows in the plurality of spatial flows are obtained by performing transmit diversity processing on one original spatial flow.

Step 102: Transmit the plurality of precoded data streams.

In an existing LTE/LTE-A system, a spatial flow is a data layer that is obtained after layer mapping. The data layer is also referred to as a data stream, a symbol stream, or a symbol layer. In this embodiment of this application, a transmit diversity processing operation is added between layer mapping and precoding. When the transmit end device sends data to a plurality of receive end devices, transmit diversity processing may be performed on some of spatial flows that are obtained after layer mapping, but not on the rest of the spatial flows that are obtained after layer mapping. Therefore, the plurality of spatial flows include spatial flows that are obtained through transmit diversity processing and the spatial flows on which transmit diversity processing is not performed. For the spatial flows that are obtained through transmit diversity processing, a spatial flow before the transmit diversity processing is referred to as an original spatial flow. In this embodiment of this application, the transmit diversity processing may be in a diversity manner, such as the foregoing STTD, SFTD, TSTD, FSTD, or OTD.

During multi-user, multiple-input, multiple-output (MU-MIMO) transmission, a precoding vector corresponding to a spatial flow may be designed as being orthogonal to a channel of another receiving device other than a target receiving device of the spatial flow, to cancel interference. A precoded data stream that is obtained through precoding is also referred to as a precoded symbol stream. For precoding in this application, refer to various precoding schemes used in an existing LTE standard, for example, a codebook-based precoding scheme and a non-codebook-based precoding scheme.

A precoding-based transmission process may be briefly represented by using the following formula:

r=HWs+n, where

r is a signal stream received by a receive end device, H is a channel matrix, W is a precoding matrix, s is a spatial flow (also referred to as a symbol layer, a symbol stream, or a spatial layer), and n is channel noise. In the foregoing formula, HW is referred to as an equivalent channel matrix H_{eff}, and the equivalent channel matrix corresponds to a precoded channel. The equivalent channel matrix H_{eff} may be estimated by using a demodulation reference signal (DMRS), because the DMRS and the spatial flow s are precoded by using the same precoding matrix W. DMRSs are mapped to spatial flows in a one-to-one manner. Therefore, a quantity of DMRSs is usually equal to a quantity of spatial flows.

In one embodiment, it may be assumed that the noise represented by a noise vector nₖ is additive white Gaussian noise (Additive white Gaussian noise (AWGN)). A receive end device k may obtain, from a received signal stream vector rₖ, an estimated value of a spatial flow vector sₖ sent by the transmit end device. A specific process thereof may be represented by using the following formula:

ŝₖ=Gₖ·rₖ, where

ŝₖ is the estimated value of the spatial flow vector sₖ, and Gₖ is an Lₖ×Rₖ-order MIMO equalization matrix of the receive end device k. The MIMO equalization matrix Gₖ may be calculated by using a plurality of receiving algorithms, for example but not limited to, zero-forcing (ZF), minimum mean square error (MMSE), maximum likelihood (ML), maximum ratio combining (MRC), and successive interference cancellation (SIC). For example, if the ZF algorithm is used,

Gₖ=[(Hₖ^{e})^{H}·Hₖ^{e}]⁻¹·(Hₖ^{e})^{H}, where

(x)^{H} represents a conjugate transpose operation, and different receiving algorithms may use different parameters. For example, some algorithms may need to use a variance of the noise vector nₖ, in addition to the equivalent channel matrix H_{eff}. In addition, some algorithms may use other totally different parameters. Therefore, equalization matrices Gₖ obtained by using different receiving algorithms may be different. Moreover, in addition to calculation based on the foregoing formula, some steps in the foregoing process may be implemented in a table lookup manner.

In this embodiment, if transmit diversity processing performed on an original spatial flow is also considered as a type of precoding, the method in this embodiment is equivalent to performing two-level precoding on an original spatial flow on which layer mapping has been performed, and may be represented as Y=F1(F2(S)). F2 represents precoding (that is, transmit diversity processing) corresponding to transmit diversity, F1 represents beamforming precoding (i.e., conventional precoding or precoding defined in the LTE standard), and S represents an original spatial flow. A quantity of ports used to finally send the precoded data streams varies with a transmit diversity processing manner. For example, when the transmit diversity processing manner is SFTD, the quantity of ports is 2; or when the transmit diversity processing manner is FSTD, the quantity of ports is 4.

In this embodiment, some spatial flows in the plurality of spatial flows may be spatial flows that are obtained through transmit diversity processing, and others may be spatial flows on which transmit diversity processing is not performed. In other words, both transmit diversity processing and precoding processing have been performed on some spatial flows, but only precoding processing has been performed on other spatial flows. A method for performing both transmit diversity processing and precoding processing on a spatial flow is referred to as a transmit-diversity-based beamforming transmission method below.

The method in this embodiment may be applied to a single-user MIMO (SU-MIMO) scenario, or may be applied to a multi-user MIMO (MU-MIMO) scenario. When the method is applied to an SU-MIMO system, only particular UE is allowed to use some ports of a time-frequency resource to perform the transmit-diversity-based beamforming transmission method, and remaining ports cannot be allocated to other UEs. In other words, the original spatial flow corresponds to a first receive end device, and that the original spatial flow corresponds to the first receive end device means that a device for receiving an original data stream is the first receive end device. For example, on a same time-frequency resource, if UE 0 performs transmit-diversity-based beamforming transmission by using a port x and a port x+1, remaining ports cannot be allocated to other UEs, to avoid interference between data streams. In one embodiment, the UE 0 performs transmit diversity processing on an original spatial flow to obtain spatial flows, precodes the spatial flows to obtain precoded data streams, and transmits the precoded data streams by using the port x and the port x+1.

In one embodiment, in the SU-MIMO scenario, some spatial flows in a plurality of spatial flows may be obtained by performing transmit diversity on an original spatial flow, and other spatial flows do not experience transmit diversity processing. There may be more than one original spatial flow and more than one spatial flow on which transmit diversity processing is not performed. Certainly, the plurality of spatial flows in the SU-MIMO scenario may all be spatial flows that are obtained through transmit diversity processing, and these spatial flows may correspond to one or more original spatial flows. In other words, the spatial flows that are precoded in step 101 are obtained by performing transmit diversity on one or more original spatial flows, and the original spatial flows correspond to same UE.

When the method is applied to the MU-MIMO scenario, the plurality of spatial flows correspond to a plurality of receive end devices. In a scenario, at least two spatial flows in the plurality of spatial flows are obtained by performing transmit diversity processing on one original spatial flow, and the original spatial flow corresponds to a first receive end device. The plurality of spatial flows include at least one spatial flow on which transmit diversity processing is not performed, and the spatial flow on which transmit diversity processing is not performed corresponds to a second receive end device. In this way, a same time-frequency resource is used for both transmit diversity and spatial multiplexing, thereby improving time-frequency resource utilization. It is assumed that: A base station has ports x, x+1, . . . , and y in total, the first receive end device is UE 0, the second receive end device is UE 1, the UE 0 sends data by using the transmit-diversity-based beamforming transmission method, the UE 0 uses the ports x+1 and the port x+2, a transmit diversity processing manner used by the UE 0 is SFTD, remaining ports excluding the port x+1 and the port x+2 are allocated to UE 2, and the UE 2 performs transmission by using closed-loop spatial multiplexing (CLSM). Therefore, in the MU-MIMO scenario, for a plurality of UEs in simultaneous scheduling, at least one UE performs data transmission by using the transmit-diversity-based beamforming transmission method. In addition, for the UE that performs data transmission by using the transmit-diversity-based beamforming transmission method, spatial flows of the UE may further include a spatial flow on which diversity processing is not performed. In conclusion, for one or more UEs in the plurality of UEs, spatial flows corresponding to the one or more UEs may include spatial flows that are obtained through transmit diversity, a spatial flow on which transmit diversity is not performed, or any combination of the foregoing two types of spatial flows. In addition, there may be more than one spatial flow on which transmit diversity is not performed, and the spatial flows that are obtained through transmit diversity may correspond to one or more original spatial flows.

For example, at least two spatial flows in the plurality of spatial flows are obtained by performing transmit diversity processing on one original spatial flow, and at least two spatial flows in the plurality of spatial flows are obtained by performing transmit diversity processing on another original spatial flow. In other words, the plurality of spatial flows are obtained by performing transmit diversity processing on at least two different original spatial flows. The original spatial flow corresponds to the first receive end device, and the another original spatial flow corresponds to a third receive end device, so that a same time-frequency resource is used for both transmit diversity and spatial multiplexing, thereby improving time-frequency resource utilization. Still using the foregoing example as an example, the first receive end device is the UE 0, the second receive end device is the UE 1, and the third receive end device is UE 2. Both the UE 0 and the UE 2 use the transmit-diversity-based beamforming transmission method. The UE 1 performs transmission by using CLSM. The UE 0 performs transmit-diversity-based beamforming transmission by using the port x+1 and the port x+2. The UE 1 performs CLSM transmission by using the ports x+3, . . . , and y−2. The UE 2 performs transmit-diversity-based beamforming transmission by using the ports y−1 and y. In addition, the UE 0 and/or the UE 2 may perform CLSM transmission by using some ports. In other words, in spatial flows corresponding to same UE, some spatial flows are spatial flows that are obtained through transmit diversity, and a remaining spatial flow is a spatial flow on which transmit diversity is not performed.

In this embodiment, a plurality of spatial flows are precoded by using a plurality of precoding vectors, and different spatial flows correspond to different precoding vectors. Each spatial flow is associated with one DMRS, where the DMRS and the spatial flow are precoded by using a same precoding vector, the UE demodulates the spatial flow by using the DMRS, and the DMRS is identified by a DMRS port of the DMRS. It can be learned that each precoding vector corresponds to one DMRS port, and different precoding vectors correspond to different DMRS ports. The DMRS is used for channel demodulation. The transmit end device precodes DMRSs of the plurality of spatial flows, to obtain a plurality of precoded DMRSs, and sends the plurality of precoded DMRSs. Each spatial flow corresponds to one DMRS, and a precoded data stream that is obtained by precoding each spatial flow may be demodulated by using a DMRS that corresponds to the spatial flow. This is because a precoding vector used by each spatial flow is the same as a precoding vector used by a DMRS of the spatial flow, but transmit diversity processing does not need to be performed on the DMRS of the spatial flow. In other words, after transmit diversity is performed on an original spatial flow to obtain at least two spatial flows, these spatial flows are associated with respective DMRSs, and these DMRSs may be different from each other. At a receive end, a receive end device demodulates a received precoded data stream based on a DMRS that corresponds to a DMRS port, to obtain a spatial flow. If the at least two spatial flows are obtained by performing transmit diversity on an original spatial flow, after the spatial flows are obtained through demodulation, the original spatial flow further needs to be restored from the at least two spatial flows based on a transmit diversity manner in which a transmit end has generated the spatial flows.

In this embodiment, because the transmit end uses the transmit-diversity-based beamforming transmission method, when needing to perform data demodulation, the receive end device not only needs to learn a DMRS port number, but also needs to learn a transmit diversity processing manner used by the transmit end. The transmit end may send, to the receive end device by using downlink signaling, port information of the DMRS of each spatial flow and/or information about a transmit diversity processing manner used by the spatial flow. The receive end device performs data demodulation based on the port information of the DMRS of each spatial flow and/or the transmit diversity processing manner used by the spatial flow. The transmit end device may send, in the following several manners, the port information of the DMRS of the spatial flow and/or the information about the transmit diversity processing manner used by the spatial flow.

(1) Send, by using downlink signaling, a port identifier of the DMRS of each spatial flow and information about a transmit diversity processing manner of the spatial flows that are obtained through transmit diversity processing.

For example, a base station indicates, to UE 0 by using downlink signaling, that DMRS port identifiers sent by the base station are x+1 and x+2, and indicates, to the UE 0, that a transmit diversity processing manner used by the base station is SFTD. For another example, a base station indicates, to UE 0 by using downlink signaling, that DMRS port identifiers sent by the base station are x, x+1, x+2, and x+3, and indicates, to the UE, that a transmit diversity processing manner used by the base station is FSTD. When the transmit diversity processing manner is indicated to the UE by using downlink signaling, several fixed bits may be allocated to specify the transmit diversity processing manner. For example, two bits are used to indicate the transmit diversity processing manner, and the two bits may indicate four transmit diversity processing manners in total. For example, 00 represents SFTD, and 01 represents FSTD. Certainly, the transmit diversity processing manner may be indicated in another manner. When spatial flows of same UE include both spatial flows that are obtained through transmit diversity and spatial flows on which transmit diversity is not performed, spatial flows on which transmit diversity has been performed and a corresponding transmit diversity manner need to be indicated. In addition, the spatial flows on which transmit diversity is not performed further need to be indicated.

(2) Send a port identifier of the DMRS of each spatial flow by using downlink signaling, where a port or a port quantity of the DMRS of each spatial flow uniquely corresponds to one transmit diversity processing manner.

In this manner, a port identifier or a port quantity of a DMRS of a spatial flow may implicitly indicate a transmit diversity processing manner, and there is a mapping relationship between the port identifier or the port quantity and the transmit diversity processing manner. The port or the port quantity of the DMRS of each spatial flow uniquely corresponds to one transmit diversity processing manner. The receive end device determines the transmit diversity processing manner based on the port identifier or the port quantity of the DMRS and the mapping relationship. For example, the mapping relationship is as follows: SFTD needs to be used on a port x+1 and a port x+2, or SFTD needs to be used when two ports are used. When the receive end device learns, by using downlink signaling, that port identifiers of a DMRS of a spatial flow are x+1 and x+2, the receive end device determines, based on the mapping relationship, that a transmit diversity processing manner used by the transmit end device is SFTD.

(3) Send, by using downlink signaling, information about a transmit diversity processing manner of the spatial flows that are obtained through transmit diversity processing, where a transmit diversity processing manner used by each spatial flow uniquely corresponds to a group of DMRS ports.

The information about the transmit diversity processing manner may be an identifier of the transmit diversity processing manner, or the transmit diversity processing manner is indicated by using one or more bits. In this manner, a transmit diversity processing manner used by a DMRS of a spatial flow may implicitly indicate DMRS ports. In addition, there is a mapping relationship between a transmit diversity processing manner and port identifiers. A transmit diversity processing manner used by each spatial flow uniquely corresponds to a group of DMRS ports. The receive end device determines DMRS ports based on the mapping relationship and a transmit diversity processing manner that is used by a DMRS. For example, a base station indicates, to UE 0 by using downlink signaling, that a transmit diversity processing manner used by the base station is SFTD. The mapping relationship is as follows: A port x+1 and a port x+2 need to be used when transmit diversity processing is performed by using SFTD. Then, the UE 0 may learn, based on the mapping relationship and the transmit diversity processing manner that is indicated by the base station, that port numbers of a DMRS are x+1 and x+2.

(4) Send a port quantity of the DMRS of each spatial flow by using downlink signaling, where the port quantity of the DMRS of each spatial flow uniquely corresponds to one transmit diversity processing manner and a group of DMRS ports.

In this manner, a transmit diversity processing manner used by a spatial flow and DMRS ports of the spatial flow are implicitly indicated by using a port quantity of a DMRS of the spatial flow. In addition, there is a mapping relationship between a transmit diversity processing manner, a port quantity of a DMRS, and DMRS ports; and a port quantity of the DMRS of each spatial flow uniquely corresponds to one transmit diversity processing manner and a group of DMRS ports. The receive end device determines a transmit diversity processing manner and DMRS ports based on a port quantity of a DMRS and the mapping relationship. For example, a base station indicates, to UE by using downlink signaling, that a port quantity of a DMRS of a spatial flow is 2. The mapping relationship is as follows: When a quantity of used ports is 2, SFTD needs to be used for transmit diversity processing, and ports numbered x+1 and x+2 need to be used for a DMRS of a spatial flow. The UE determines, based on the mapping relationship and the port quantity, indicated by the base station, of the DMRS of the spatial flow, that a transmit diversity processing manner used by the spatial flow is SFTD, and port numbers of the DMRS of the spatial flow are x+1 and x+2.

(5) Send, by using downlink signaling, a port quantity of the DMRS of each spatial flow and information about a transmit diversity processing manner of the spatial flows that are obtained through transmit diversity processing, where the port quantity of the DMRS of each spatial flow and a transmit diversity processing manner that is used by each spatial flow together uniquely correspond to a group of DMRS ports.

In this manner, DMRS ports of a spatial flow are implicitly indicated by using a port quantity of a DMRS of the spatial flow and a transmit diversity processing manner that is used by the spatial flow. In addition, there is a mapping relationship between a transmit diversity processing manner, a port quantity of a DMRS, and DMRS ports. A port quantity of the DMRS of each spatial flow and a transmit diversity processing manner that is used by each spatial flow together uniquely correspond to a group of DMRS ports. The receive end device determines DMRS ports based on a port quantity of a DMRS, a transmit diversity processing manner that is used by a spatial flow, and the mapping relationship, where the port quantity of the DMRS and the transmit diversity processing manner that is used by the spatial flow are indicated by the transmit end device. For example, a base station indicates, to UE 0 by using downlink signaling, that a transmit diversity processing manner used by a spatial flow is SFTD and a port quantity of a DMRS of the spatial flow is 2. The mapping relationship is as follows: When a transmit diversity processing manner used by a spatial flow is SFTD and a port quantity of a DMRS of the spatial flow is 2, DMRS ports numbered x+1 and x+2 need to be used for the spatial flow.

It should be noted that, to more clearly describe the technical solutions provided in this application, a spatial flow obtained after layer mapping in the existing LTE standard is used to represent an original spatial flow or a spatial flow on which transmit diversity processing is not performed in this application. However, a person skilled in the art should understand that, a spatial flow in this application may generally mean any data stream (for example, a modulated symbol stream) that is obtained after processing such as coding and modulation and that needs to be precoded and transmitted, in addition to a spatial flow obtained after layer mapping in the LTE standard.

In this embodiment, the transmit end device precodes the plurality of spatial flows, to obtain the plurality of precoded data streams, and transmits the plurality of precoded data streams, where at least two spatial flows in the plurality of spatial flows are obtained by performing transmit diversity processing on one original spatial flow. In this way, some spatial flows in a plurality of spatial flows on a same time-frequency resource can be transmitted in a transmit-diversity-based beamforming transmission manner, and other spatial flows can be transmitted in a spatial multiplexing manner, thereby improving time-frequency resource utilization.

FIG. 3 is a flowchart of a data receiving method according to one embodiment. The method in this embodiment is performed by a receive end device. The receive end device may be a base station or UE. As shown in FIG. 3, the method in this embodiment includes the following steps:

Step 201: Receive a plurality of precoded data streams, where the plurality of precoded data streams are obtained by precoding a plurality of spatial flows, and at least two spatial flows in the plurality of spatial flows are obtained by performing transmit diversity processing on one original spatial flow.

Step 202: Restore the at least two spatial flows from the plurality of precoded data streams.

Step 203: Restore the original spatial flow based on the at least two spatial flows.

The receive end device may receive a plurality of precoded data stream. Some precoded data streams have experienced transmit diversity processing, but other data streams do not experience transmit diversity processing. In addition, for a particular receive end device, some precoded data streams are interference information, and the receive end device determines, from the plurality of precoded data streams, a data stream needed by the receive end device. In this embodiment, the receive end device restores the at least two spatial flows from the plurality of precoded data streams, where the at least two spatial flows are obtained by performing transmit diversity processing on one original spatial flow, and the original spatial flow corresponds to a first receive end device. Therefore, the receive end device is the first receive end device.

To restore the at least two spatial flows from the plurality of precoded data streams, the receive end device needs to obtain precoded DMRSs of the at least two spatial flows and DMRS ports of the at least two spatial flows. Therefore, the receive end device further receives a plurality of precoded DMRSs. The plurality of precoded DMRSs are obtained by precoding DMRSs of the plurality of spatial flows, and different spatial flows correspond to different precoding vectors. Each spatial flow is associated with one DMRS, where the DMRS and the spatial flow are precoded by using a same precoding vector, the UE demodulates the spatial flow by using the DMRS, and the DMRS is identified by a DMRS port of the DMRS. Because the precoding vector of the DMRS is the same as the precoding vector of the spatial flow, the at least two spatial flows may be demodulated based on the precoded DMRSs of the at least two spatial flows and the DMRS ports of the at least two spatial flows. The at least two spatial flows are obtained by performing transmit diversity processing on a same original spatial flow, and the receive end device combines the at least two spatial flows based on a transmit diversity processing manner that is used by a transmit end device, to obtain the original spatial flow. A port number of a DMRS of a spatial flow and a transmit diversity processing manner that is used by the spatial flow may be sent by the transmit end device to the receive end device by using downlink signaling. For a specific sending manner, refer to description of the embodiment of FIG. 2. Details are not described herein again.

In this embodiment, the plurality of precoded data streams are received, where the plurality of precoded data streams are obtained by precoding the plurality of spatial flows, and at least two spatial flows in the plurality of spatial flows are obtained by performing transmit diversity processing on one original spatial flow; and then, the at least two spatial flows are restored from the plurality of precoded data streams, and the original spatial flow is restored based on the at least two spatial flows. In this way, some spatial flows in a plurality of spatial flows on a same time-frequency resource can be transmitted in a transmit-diversity-based beamforming transmission manner, and other spatial flows can be transmitted in a spatial multiplexing manner, thereby improving time-frequency resource utilization.

FIG. 4 is a schematic structural diagram of a data sending apparatus according to one embodiment. The data sending apparatus is integrated into UE or a base station. As shown in FIG. 4, the data sending apparatus provided in this embodiment includes:

a processing module 11 configured to precode a plurality of spatial flows, to obtain a plurality of precoded data streams, where at least two spatial flows in the plurality of spatial flows are obtained by performing transmit diversity processing on one original spatial flow; and

a sending module 12 configured to transmit the plurality of precoded data streams.

In one embodiment, the original spatial flow corresponds to a first receive end device.

In one embodiment, at least one spatial flow in the plurality of spatial flows corresponds to a second receive end device.

In one embodiment, at least two spatial flows in the plurality of spatial flows are obtained by performing transmit diversity processing on another original spatial flow, and the another original spatial flow corresponds to a third receive end device.

In one embodiment, the transmit diversity processing is space-time transmit diversity processing, space-frequency transmit diversity processing, or space-time-frequency transmit diversity processing.

In one embodiment, different spatial flows correspond to different precoding vectors, each precoding vector corresponds to one DMRS port, and different precoding vectors correspond to different DMRS ports.

In one embodiment, the processing module 11 is further configured to: precode demodulation reference signals of the plurality of spatial flows, to obtain a plurality of precoded demodulation reference signals, where each spatial flow corresponds to one demodulation reference signal, and a precoding vector used by each spatial flow is the same as a precoding vector used by the demodulation reference signal of each spatial flow. In one embodiment, the sending module 12 is further configured to send the plurality of precoded demodulation reference signals.

The data sending apparatus in this embodiment may be configured to perform the method in FIG. 2. Specific implementations and technical effects of the apparatus are similar to those of the method in FIG. 2, and details are not described herein again.

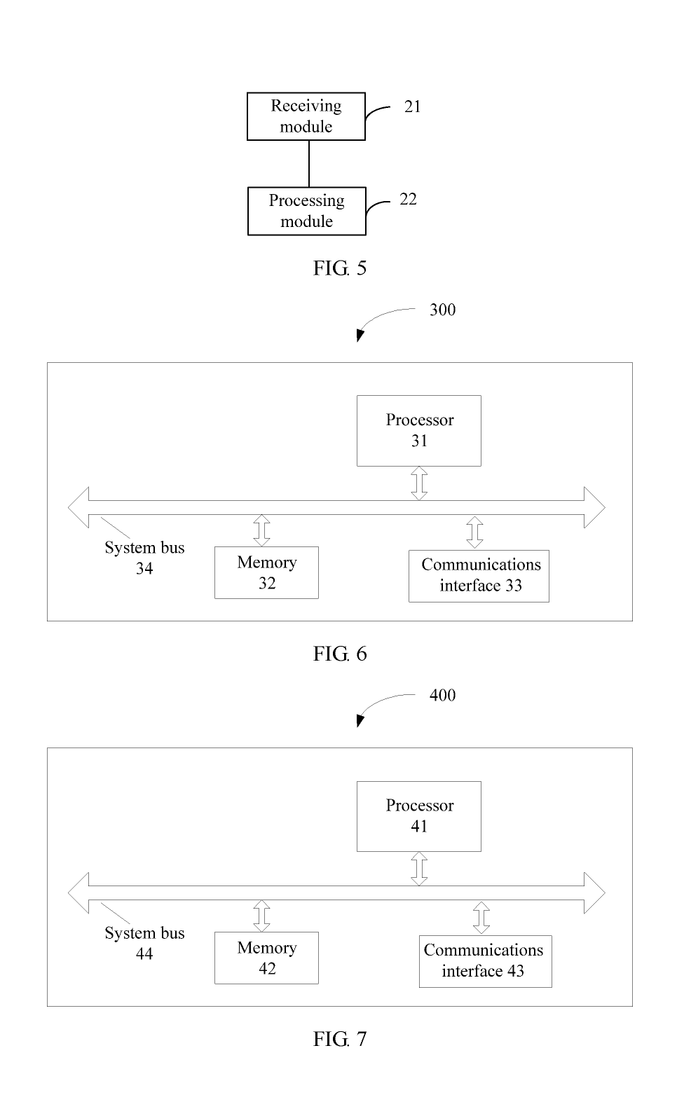

FIG. 5 is a schematic structural diagram of a data receiving apparatus according to one embodiment. The data receiving apparatus is integrated into UE or a base station. As shown in FIG. 5, the data receiving apparatus provided in this embodiment includes:

a receiving module 21 configured to receive a plurality of precoded data streams, where the plurality of precoded data streams are obtained by precoding a plurality of spatial flows, and at least two spatial flows in the plurality of spatial flows are obtained by performing transmit diversity processing on one original spatial flow; and

a processing module 22 configured to restore the at least two spatial flows from the plurality of precoded data streams, where

the processing module 22 is further configured to restore the original spatial flow based on the at least two spatial flows.

In one embodiment, the original spatial flow corresponds to a first receive end device.

In one embodiment, at least one spatial flow in the plurality of spatial flows corresponds to a second receive end device.

In one embodiment, at least two spatial flows in the plurality of spatial flows are obtained by performing transmit diversity processing on another original spatial flow, and the another original spatial flow corresponds to a third receive end device.

In one embodiment, the transmit diversity processing is space-time transmit diversity processing, space-frequency transmit diversity processing, or space-time-frequency transmit diversity processing.

In one embodiment, different spatial flows correspond to different precoding vectors, each precoding vector corresponds to one DMRS port, and different precoding vectors correspond to different DMRS ports.

In one embodiment, the receiving module 21 is further configured to receive a plurality of precoded demodulation reference signals, where the plurality of precoded demodulation reference signals are obtained by precoding demodulation reference signals of the plurality of spatial flows, each spatial flow corresponds to one demodulation reference signal, and a precoding vector used by each spatial flow is the same as a precoding vector used by the demodulation reference signal of each spatial flow. In one embodiment, the processing module 22 is configured to restore the at least two spatial flows from the plurality of precoded data streams based on precoded demodulation reference signals of the at least two spatial flows.

The data receiving apparatus in this embodiment may be configured to perform the method in FIG. 3. Specific implementations and technical effects of the apparatus are similar to those of the method in FIG. 3, and details are not described herein again.

FIG. 6 is a schematic structural diagram of a data sending apparatus according to one embodiment. As shown in FIG. 6, the data sending apparatus 300 provided in this embodiment includes a processor 31, a memory 32, a communications interface 33, and a system bus 34. The memory 32 and the communications interface 33 are connected to and communicate with the processor 31 by using the system bus 34. The memory 32 is configured to store a computer execution instruction. The communications interface 33 is configured to communicate with another device. The processor 31 is configured to run the computer execution instruction, to perform the following method:

precoding a plurality of spatial flows to obtain a plurality of precoded data streams, where at least two spatial flows in the plurality of spatial flows are obtained by performing transmit diversity processing on one original spatial flow; and

transmitting the plurality of precoded data streams.

The data sending apparatus in this embodiment may be configured to perform the method in FIG. 2. Specific implementations and technical effects of the apparatus are similar to those of the method in FIG. 2, and details are not described herein again.

FIG. 7 is a schematic structural diagram of a data receiving apparatus according to one embodiment. As shown in FIG. 7, a data sending apparatus 400 provided in this embodiment includes a processor 41, a memory 42, a communications interface 43, and a system bus 44. The memory 42 and the communications interface 43 are connected to and communicate with the processor 41 by using the system bus 44. The memory 42 is configured to store a computer execution instruction. The communications interface 43 is configured to communicate with another device. The processor 41 is configured to run the computer execution instruction, to perform the following method:

receiving a plurality of precoded data streams, where the plurality of precoded data streams are obtained by precoding a plurality of spatial flows, and at least two spatial flows in the plurality of spatial flows are obtained by performing transmit diversity processing on one original spatial flow;

restoring the at least two spatial flows from the plurality of precoded data streams; and

restoring the original spatial flow based on the at least two spatial flows.

The data receiving apparatus in this embodiment may be configured to perform the method in FIG. 3. Specific implementations and technical effects of the apparatus are similar to those of the method in FIG. 3, and details are not described herein again.

In the several embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of hardware combined with a software functional unit.

When the foregoing integrated unit is implemented in a form of a software functional unit, the integrated unit may be stored in a computer readable storage medium. The software functional unit is stored in a storage medium and includes several instructions for instructing a computer device (which may be a personal computer, a server, a network device, or the like) or a processor to perform some of the steps of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

What is claimed is:

1. A method of sending data, comprising:
precoding a plurality of spatial flows to obtain a plurality of precoded data streams, wherein at least two spatial flows in the plurality of spatial flows are obtained by performing transmit diversity processing on one original spatial flow; and
transmitting the plurality of precoded data streams.

2. The method according to claim 1, wherein the original spatial flow corresponds to a first receive end device.

3. The method according to claim 1, wherein at least one spatial flow in the plurality of spatial flows corresponds to a second receive end device.

4. The method according to claim 1, wherein the at least two spatial flows in the plurality of spatial flows are obtained by performing transmit diversity processing on another original spatial flow corresponding to a third receive end device.

5. The method according to claim 1, wherein the transmit diversity processing is space-time transmit diversity processing, space-frequency transmit diversity processing, or space-time-frequency transmit diversity processing.

6. The method according to claim 1, wherein different spatial flows in the plurality of spatial flows correspond to different precoding vectors, each precoding vector corresponds to one demodulation reference signal (DMRS) port, and the different precoding vectors correspond to different DMRS ports.

7. The method according to claim 1, further comprising:
precoding demodulation reference signals of the plurality of spatial flows to obtain a plurality of precoded demodulation reference signals, wherein each spatial flow corresponds to one demodulation reference signal, and a precoding vector used by each spatial flow is a precoding vector used by the demodulation reference signal of each spatial flow; and
sending the plurality of precoded demodulation reference signals.

8. A method of receiving data, comprising:
receiving a plurality of precoded data streams obtained by precoding a plurality of spatial flows, and at least two spatial flows in the plurality of spatial flows are obtained by performing transmit diversity processing on one original spatial flow;
restoring the at least two spatial flows from the plurality of precoded data streams; and
restoring the original spatial flow based on the at least two spatial flows.

9. The method according to claim 8, wherein the original spatial flow corresponds to a first receive end device.

10. The method according to claim 8, wherein at least one spatial flow in the plurality of spatial flows corresponds to a second receive end device.

11. The method according to claim 8, wherein the at least two spatial flows in the plurality of spatial flows are obtained by performing transmit diversity processing on another original spatial flow corresponding to a third receive end device.

12. The method according to claim 8, wherein the transmit diversity processing is space-time transmit diversity processing, space-frequency transmit diversity processing, or space-time-frequency transmit diversity processing.

13. The method according to claim 8, wherein different spatial flows correspond to different precoding vectors, each precoding vector corresponds to one demodulation reference signal (DMRS) port, and the different precoding vectors correspond to different DMRS ports.

14. The method according to claim 8, further comprising:
receiving a plurality of precoded demodulation reference signals obtained by precoding demodulation reference signals of the plurality of spatial flows, each spatial flow corresponding to one demodulation reference signal, and a precoding vector used by each spatial flow is a precoding vector used by the demodulation reference signal of each spatial flow; and
wherein restoring the at least two spatial flows from the plurality of precoded data streams comprises:
restoring the at least two spatial flows from the plurality of precoded data streams based on precoded demodulation reference signals of the at least two spatial flows.

15. An apparatus for sending data, comprising:
a processing module configured to precode a plurality of spatial flows to obtain a plurality of precoded data streams, wherein at least two spatial flows in the plurality of spatial flows are obtained by performing transmit diversity processing on one original spatial flow; and
a sending module configured to transmit the plurality of precoded data streams.

16. The apparatus according to claim 15, wherein the original spatial flow corresponds to a first receive end device.

17. The apparatus according to claim 15, wherein at least one spatial flow in the plurality of spatial flows corresponds to a second receive end device.

18. The apparatus according to claim 15, wherein the at least two spatial flows in the plurality of spatial flows are obtained by performing transmit diversity processing on another original spatial flow corresponding to a third receive end device.

19. The apparatus according to claim 15, wherein the transmit diversity processing is space-time transmit diversity processing, space-frequency transmit diversity processing, or space-time-frequency transmit diversity processing.

20. The apparatus according to claim 15, wherein different spatial flows correspond to different precoding vectors, each precoding vector corresponds to one demodulation reference signal (DMRS) port, and the different precoding vectors correspond to different DMRS ports.
